(19) United States
(12) Patent Application Publication
(10) Pub. No.: US 2008/0266737 A1
(43) Pub. Date: Oct. 30, 2008

(54) Biometric reader protection system and method

(76) Inventors: Patrick R. Conway, Spring, TX (US); Ann A. Villegas, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/789,581

(22) Filed: Apr. 25, 2007

(51) Int. Cl. H02H 3/027; H02H 3/02; H02H 3/08

(52) U.S. Cl. 361/87; 361/93.1; 361/93.2

(57) ABSTRACT

A biometric reader protection system comprises a power controller configured to determine an amount of current flow to a biometric reader and interrupt the current flow to the biometric reader if the current flow exceeds a predetermined threshold.

### BACKGROUND

Biometric readers are often susceptible to being exposed to electrostatic discharge (ESD) energy. For example, in a fingerprint reader biometric application, contact between a user's finger and the reader may cause an ESD. If the ESD energy is large enough, the ESD energy may cause a malfunction of the biometric reader.

### BRIEF DESCRIPTION OF THE DRAWINGS

For a more complete understanding of the present application, the objects and advantages thereof, reference is now made to the following descriptions taken in conjunction with the accompanying drawings, in which:

FIG. 1 is a diagram illustrating an embodiment of a biometric reader protection system; and

FIG. 2 is a diagram illustrating an embodiment of a biometric reader protection method.

### DETAILED DESCRIPTION OF THE DRAWINGS

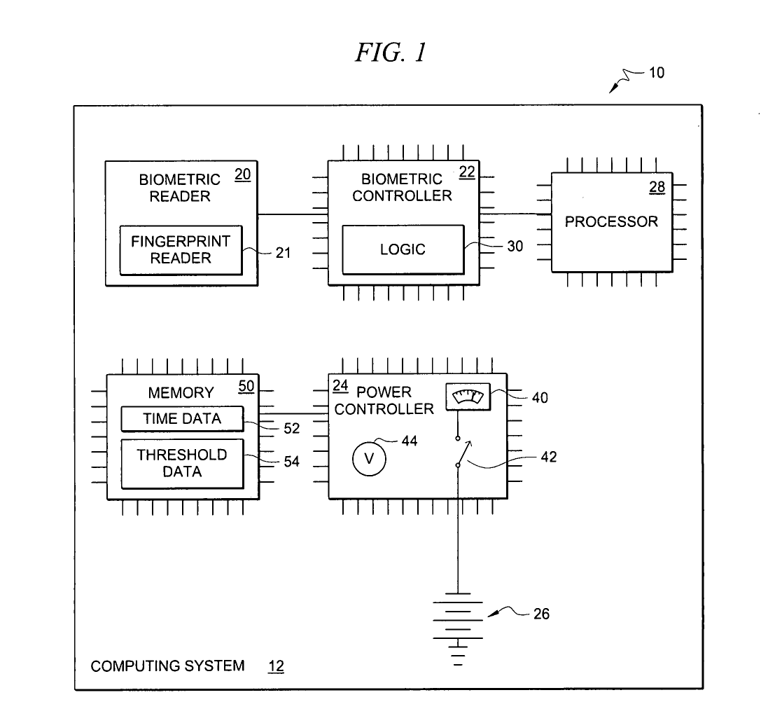

FIG. 1 is a diagram illustrating an embodiment of a biometric reader protection system 10. In the embodiment illustrated in FIG. 1, system 10 is embodied in a computing system 12. Computing system 12 may comprise a laptop computer, a tablet computer, a desktop computer, a personal digital assistant, a gaming device, or any other type of portable or non-portable computing device. However, it should also be understood that system 10 may be configured as a type of stand-alone device/system (e.g., a wall-mounted biometric reader for controlling access to a room or other secure area).

In the embodiment illustrated in FIG. 1, system 10 comprises a biometric reader 20, a biometric controller 22 for controlling biometric reader 20, a power controller 24, a power supply 26 and a processor 28. In some embodiments, biometric reader 20 comprises a fingerprint scanner or reader 21. However, it should be understood that biometric reader 20 may comprise other types of biometric acquisition devices (e.g., a retinal scanner, facial scanner, etc.). Biometric controller 22 draws power from power supply 26 through power controller 24. Power supply 26 may comprise an on-board power supply (e.g., a battery power supply) or an external power supply (e.g., provided by an external source such as an adapter, an electrical outlet, etc.).

Biometric controller 22 supplies electrical power and/or otherwise controls the operation of biometric reader 20. In the embodiment illustrated in FIG. 1, biometric controller 22 comprises logic 30, which may be in the form of a set of executable instructions in software, hardware, firmware, or a combination thereof, used to control biometric reader 20 and processes biometric information read or otherwise acquired by biometric reader 20. Biometric controller 22 is coupled to processor 28 and sends processed biometric information to processor 28. Processor 28 operates on and/or otherwise processes the biometric information received from biometric controller 22, such as comparing the received biometric information to stored values to determine whether to grant/deny access to a secure resource.

In the embodiment illustrated in FIG. 1, power controller 24 comprises a power measuring element 40, a switch 42, and a timer 44. In some embodiments, power controller 24 comprises a semiconductor switching device implemented in an integrated circuit (IC) and is configured to interrupt and, after a predetermined period of time, automatically restore power to biometric controller 22 and biometric reader 22, thereby resetting the logic state of logic 30. For example, in some embodiments, power measuring element 40 is configured to determine whether an amount of current passing through power measuring element 40 to biometric controller 22, and thereby to biometric reader 20, exceeds a threshold and, if so, actuate switch 42 to interrupt the power flow to biometric controller 22 and biometric reader 20. For example, in some embodiments, power measuring element 40 comprises a thermal element that heats in response to an increased current flow therethrough. In response to power measuring element 40 heating to a predetermined temperature that corresponds to a particular current level, the heat causes switch 42 to transition to a non-conductive state, thereby interrupting and/or otherwise ceasing current flow through power measuring element 40. In response to power measuring element 40 cooling to a predetermined temperature, which is dependent upon an elapsed predetermined time without current flowing therethrough, the drop in temperature causes switch 42 to return to a conductive state, thereby restoring current flow through power measuring element 40 to biometric controller 22 and biometric reader 20.

In the embodiment illustrated in FIG. 1, biometric reader protection system 10 further comprises a memory 50 having time data 52 and power threshold data 54. In some embodiments, power controller 24 is configured to read and/or otherwise access time data 52 and/or threshold data 54 for use in the operation of switch 42. In some embodiments, power measuring element 40 comprises a circuit with a logic state corresponding to an amount of current and/or voltage flowing through power measuring element 40. Thus, in some embodiments, power controller 24 is configured to measure the amount of current and/or voltage flowing through power measuring element 40 and compare the measured amount to threshold data 54. In some embodiments, if the measured amount of current and/or voltage exceeds a value indicated by threshold data 54, power controller 24 causes switch 42 to transition to a non-conducting state, thereby ceasing power flow to biometric controller 22 and/or biometric reader 20. However, it should be understood that power measuring element 40 may comprise any type of system or device for determining whether a power draw associated with biometric controller 22 and/or biometric reader 20 exceeds a threshold.

In some embodiments, switch 42 is caused to transition or return to a conducting state under the control of timer 44. For example, in some embodiments, timer 44 comprises a timer circuit or other device that measures the elapsed time that switch 42 has been in a non-conductive state and automatically causes switch 42 to transition to a conductive state when a predetermined time period as indicated by time data 52 has been reached. However, it should be understood that power controller 24 may comprise another type of system or device to automatically cause switch 42 to revert to a conductive state after a predetermined time period.

Thus, system 10 enables a safe, reliable operation of biometric reader 20 by using power controller 24 to prevent biometric reader 20 from overheating and by resetting biometric controller 22 in the event of a malfunction or error condition of biometric controller 22 (e.g., an error condition resulting from electrostatic discharge (ESD), communications sent to biometric controller 22 from biometric reader 20 and/or processor 28, an anomaly in electrical power from power supply 26, etc., that may drive logic 30 into an error state). For example, if an error condition occurs associated with biometric controller 22 (e.g., logic 30 entering an error state), system 10 automatically detects the error condition by detecting an excess power draw by biometric controller 22 that would result from the error condition, which would also cause an overheating condition of biometric reader 20, and automatically interrupts the power flow to biometric controller 22 and biometric reader 20. Further, system 10 automatically restores power to biometric controller 22 and biometric reader 22 after a predetermined time period, thereby resetting the logic state of logic 30. Thus, in response to power being interrupted to biometric controller 22, power is also interrupted to biometric reader 20, thereby preventing overheating of biometric reader 20. Further, when power is restored to biometric controller 22 after a predetermined time period, logic 30 is reset to an initialized state, thereby deleting the error condition that caused the excess power draw by biometric controller 22.

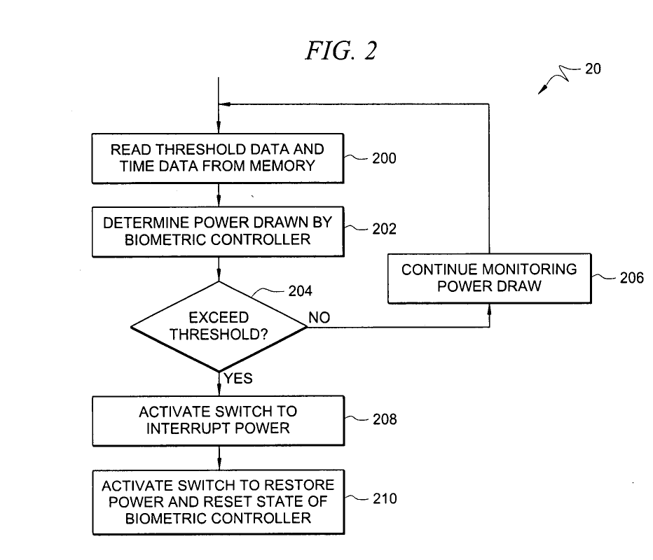

FIG. 2 is a diagram illustrating an embodiment of a biometric reader protection method. The method begins at block 200, where power controller 24 reads time data 52 and threshold data 54 from memory 50. At block 202, power controller 24 determines the power drawn by biometric controller 22 using power measuring element 40. Power controller 24 determines whether the power draw exceeds threshold data 54 at decision block 204. If, at decision block 204, the power draw does not exceed threshold data 54, power controller 24 continues monitoring the power drawn by biometric controller 22 using power measuring element 40 at block 206. If, at decision block 204, the power draw does exceed threshold data 54, switch 42 is actuated to a non-conductive state at block 208, thereby interrupting power to biometric controller 22 and biometric reader 20. At block 210, power controller 24 automatically causes switch 42 to transition to a conductive state based on the predetermined time period indicated by time data 52, thereby restoring power to biometric controller 22 and biometric reader 20 and resetting logic 30. The method returns to block 206 where power controller 24 continues monitoring the power drawn by biometric controller 22.

Thus, embodiments of system 10 substantially prevent or eliminate an overheating condition to occur for biometric reader 20, thereby substantially preventing injury to a user that may otherwise occur from such an overheating condition. Further, in some embodiments, power to biometric reader 20 is interrupted and restored in a relatively small period of time (e.g., 200 milliseconds), thereby resulting in a generally undetectable event by a user of biometric reader 20.

What is claimed is:

1. A biometric reader protection system, comprising:
a power controller configured to determine an amount of current flow to a biometric reader and interrupt the current flow to the biometric reader if the current flow exceeds a predetermined threshold.

2. The system of claim 1, wherein the power controller is configured to restore the current flow to the biometric reader after a predetermined time period has elapsed.

3. The system of claim 2, wherein the power controller is configured to read time data stored in a memory to identify the predetermined time period.

4. The system of claim 1, wherein the power controller is configured to actuate a switch to interrupt the current flow to the biometric reader.

5. The system of claim 1, wherein the biometric reader comprises a fingerprint reader.

6. The system of claim 1, wherein the power controller is configured to actuate a switch to restore the current flow to the biometric reader.

7. The system of claim 1, wherein the power controller is configured to reset a state of a biometric controller used to control the biometric reader.

8. A biometric reader protection method, comprising:
determining an amount of current flow to a biometric reader; and
interrupting the current flow to the biometric reader if the current flow exceeds a predetermined threshold.

9. The method of claim 8, further comprising restoring the current flow to the biometric reader after a predetermined time period has elapsed.

10. The method of claim 9, further comprising accessing time data disposed in a memory to identify the predetermined time period.

11. The method of claim 8, further comprising actuating a switch to interrupt the current flow to the biometric reader.

12. The method of claim 8, further comprising actuating a switch to restore the current flow to the biometric reader.

13. The method of claim 8, further comprising resetting a state of a biometric controller used to control the biometric reader.

14. A biometric reader protection system, comprising:
means for determining an amount of current flow to a biometric reader means; and
means for interrupting the current flow to the biometric reader means if the current flow exceeds a predetermined threshold.

15. The system of claim 14, further comprising means for restoring the current flow to the biometric reader means after a predetermined time period has elapsed.

16. The system of claim 14, further comprising means for resetting a state of a means for controlling the biometric reader means.

17. A biometric reader protection system, comprising:
a power controller configured to automatically reset a state of a biometric controller used to control a biometric reader in response to detecting an excess current flow condition to the biometric reader.

18. The system of claim 17, wherein the power controller is configured to interrupt and restore power to the biometric controller to reset the state of the biometric controller.

19. The system of claim 17, wherein the power controller is configured to interrupt power to the biometric reader and automatically restore power to the biometric reader after a predetermined time period has elapsed.

20. The system of claim 17, wherein the biometric reader comprises a fingerprint reader.
